(19) United States
(12) Patent Application Publication
(10) Pub. No.: US 2007/0099783 A1
(43) Pub. Date: May 3, 2007

(54) Bag forming device

(75) Inventors: Robin G. Thurgood, Marshall, MI (US); Kevin J. Laubenthal, Battle Creek, MI (US)

Correspondence Address: THOMPSON HINE L.L.P., P.O. BOX 8801, DAYTON, OH, 45401-8801, US

(73) Assignee: Rennco, Inc., Homer, MI (US)

(21) Appl. No.: 11/259,886

(22) Filed: Oct. 27, 2005

(51) Int. Cl. B31B 3/00

(52) U.S. Cl. 493/162

(57) ABSTRACT

A bag forming device includes a movement device adapted to move bag material in a folded configuration through the bag forming device along a path. The folded configuration provides a first portion and a second portion of the bag material joined at a fold. The first portion is wider in a width direction than the second portion such that the first portion extends wider than the second portion.

### BACKGROUND

Certain types of bags are commonly manually manufactured. For example, reusable or re-closable bags, such as those used in connection with bedding, are hand stitched due to the intricacies and manufacturing obstacles associated with such types of bags. Such manual labor typically increases the cost of manufacturing such bags and reduces productivity of the manufacturing entity who makes the bags.

### SUMMARY

A bag forming device includes a movement device adapted to move bag material in a folded configuration through the bag forming device along a path. The folded configuration provides a first portion and a second portion of the bag material joined at a fold. The first portion is wider in a width direction than the second portion such that the first portion extends wider than the second portion.

### BRIEF DESCRIPTION OF THE DRAWINGS

The present invention will now be described, by way of example, with reference to the accompanying drawings, in which:

FIG. 1 is a schematic view of a bag forming device according to an embodiment of the invention;

FIG. 2a is a schematic view of a bag forming device according to an embodiment of the invention;

FIG. 2b is a schematic view of a bag forming device according to an embodiment of the invention;

FIG. 3 is a schematic view of a bag forming device according to an embodiment of the invention; and

FIG. 4 is a schematic view of a bag forming device according to an embodiment of the invention.

### DETAILED DESCRIPTION

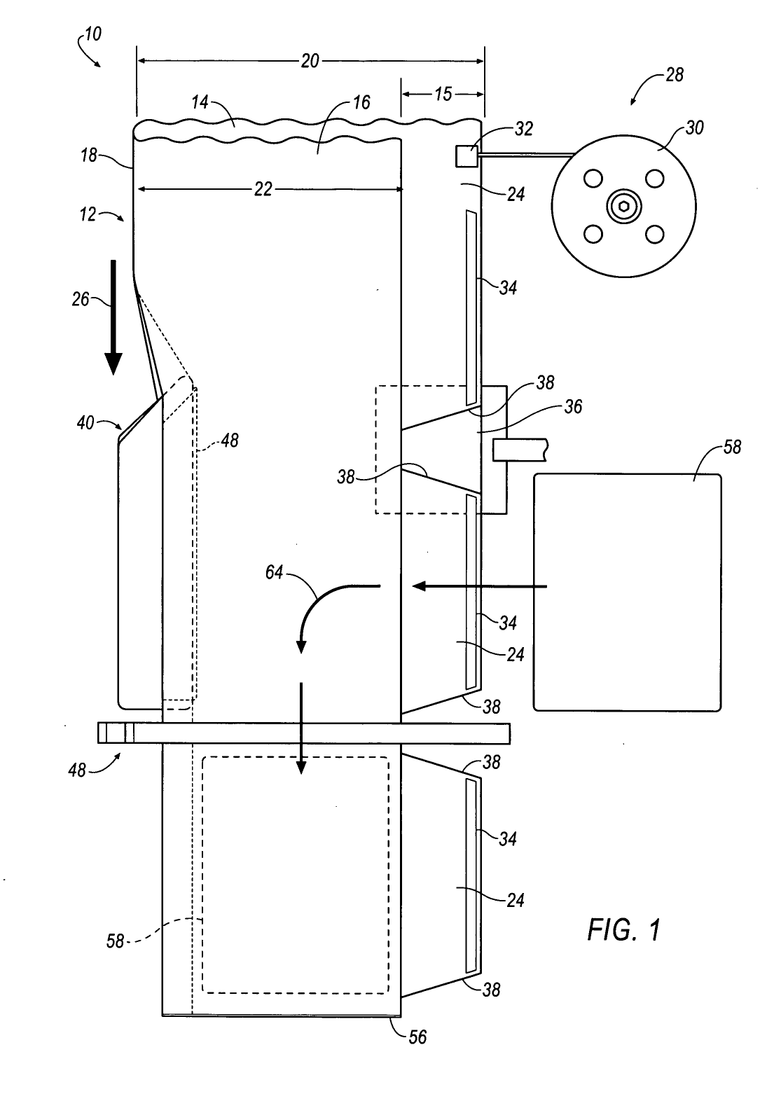

Referring now to FIG. 1, an embodiment of a bag forming device according to the invention is shown and described. In FIG. 1, an embodiment of a bag forming device is shown as including a number of components, as will be described, and passing bag material 12 through such components. The bag material 12, in an embodiment, is generally passed along the direction as shown by path 26. Of course, the path 26 may be different from that shown or may include a number of different directions in connection with rollers, pulleys or other material direction changing components. The bag material 12 generally comprises a first portion 14 and a second portion 16 connected at a fold area 18. In an embodiment, the bag material 12 is passed in a continuous fashion, such as from a roll of bag material, through the bag forming device 10 and shown. Any method known to one skilled in the art, including an appropriate organization of rollers and pulleys and other feeding devices, may be used to feed the bag material 12 through the bag forming device 10. For example, the bag material 12 may be a single sheet of rolled plastic or other bag material that is folded in the bag forming device 10 or may be pre-folded.

In an embodiment, a width 20 of the first portion 14 is greater than the width 22 of the second portion 16. As such, the greater width 20 of the first portion 14 provides a region 15 of the first portion 14 that extends beyond the second portion 16. This region 15 allows room for a seal area 24 where adhesive material may be placed and which is able to be folded over the second portion 16 to close the bag as will be discussed.

With continued referenced FIG. 1, a resealable seal formation device 28 is positioned along the path 26 to dispense resealable seals 34 on the seal area 24. In an embodiment, the resealable seal formation device 28 generally includes a seal roll 30 and a seal delivery component 32. The seal role 30 contains a role of resealable seal material that is passed from the roll 32 to the seal delivery component 32. The seal delivery component 32, in an embodiment, intermittently distributes the resealable seal material as discrete seals 34 along seal areas 24 of the bag material 12. In an embodiment, each resealable seal 34 is a removable piece of tape that, upon removal, leaves an adhesive film on the seal area 24. Accordingly, when the seal area 24 is folded over the top of the second portion 16, the remaining adhesive film adheres the seal area 24 to the second portion 16.

With continued referenced FIG. 1, a cutting tool 36, in an embodiment, is positioned along the path 26. The cutting tool 36 cuts a portion of the seal area 24 to form angled configurations 38. It will be understood that, although the angled configurations 38 are shown as angles, any geometric configuration may be used.

Further along the path 26 is located a sever and seal device 48. The sever and seal device 48, in an embodiment, severs the bag material 12 and seals it to form edges of a remaining bag. An example of such a device is provided in U.S. patent application Ser. No. 10/981,818, entitled Packaging Device and Method, filed Nov. 5, 2004 and assigned to the assignee of the present application, the entirety of which is hereby incorporated by reference. In an embodiment, the sever and seal device 48 severs the bag material 12 across both the first portion 14 and second portion 16, while adhering the first portion 14 to the second portion 16 at an area proximate the sever and seal device 48 to form a resulting edge.

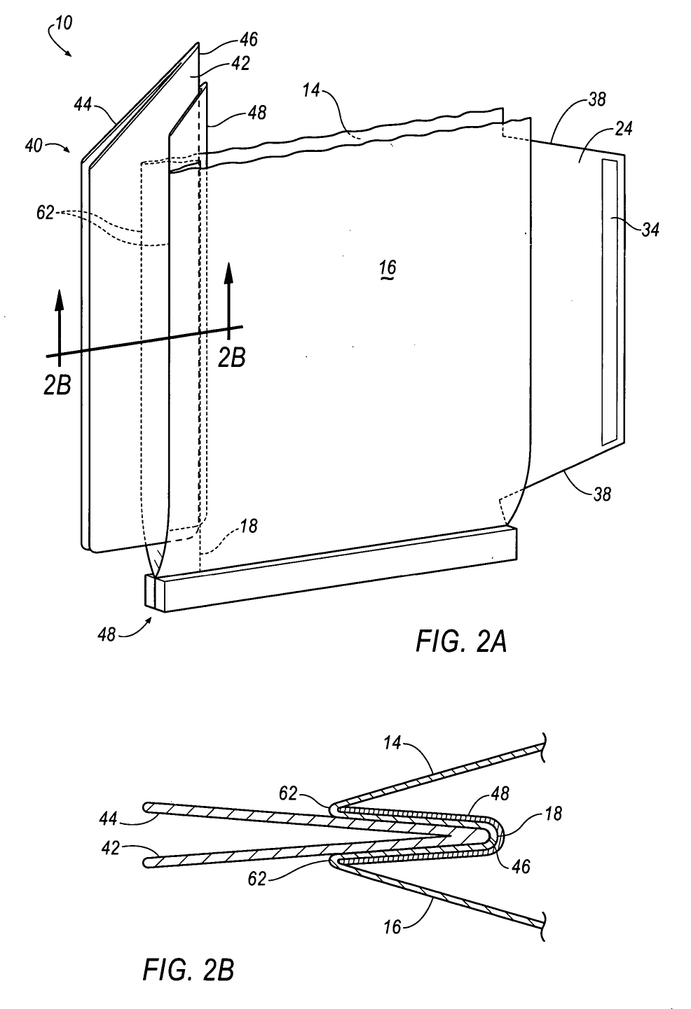

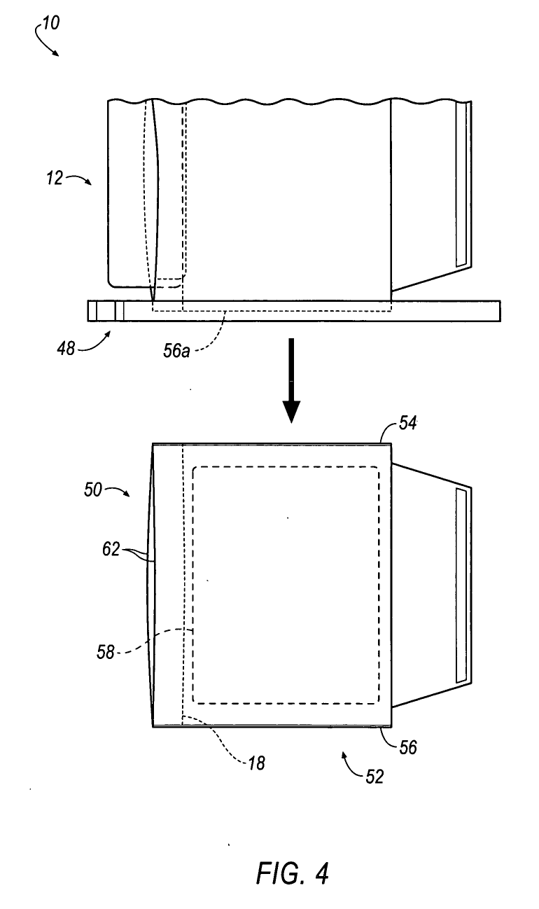

With continued reference to FIG. 1 and reference to FIGS. 2a and 2b, a pleat formation device 40 is also located along the path 26. In an embodiment, the pleat formation device 40 is an angled member extending along the path 26 and having a first angled side 42 connected to a second angled side 44 by a center portion 46. In an embodiment, the pleat formation device 40 rides against the fold 18 and pushes this material toward an interior region between the first portion 14 and the second portion 16. In an embodiment, an internal guide 48 may be positioned in coordination with the pleat formation device 40 to generally bias the bag material 12 towards the pleat formation device 40. More specifically, the center portion 46 pushes the fold 18 toward the internal guide 48 and toward the interior portion of the bag material 12. The first angled side 42 and second angled side 44, in coordination with the internal guide 48, allows the bag material 12 to stay out from this interior region. The result, as shown in FIG. 2b, is that edges 62 reside outside of the interior region of the bag material 12 and the fold 18 is pushed toward an interior region of the bag material 12. As will be described in greater detail hereinafter, movement of bag material 12 toward an interior region allows a pleat (see 50 in FIG. 4) to be formed after the sever and seal device 48 seals to edges (edges 54 and 56 in FIG. 4) of a bag.

Referring now to FIGS. 1, 3 and 4, the operation according to an embodiment of the invention is described. In FIG. 1, bag material 12 is moved along path 26 while resealable seal formation device 28 distributes resealable seals along seal areas 24. Similarly, cutting tool 36 cuts areas from seal area 24 to form angled configurations 38. Additionally, pleat formation device 40 presses bag material 12 toward an interior region between first portion 14 and second portion 16.

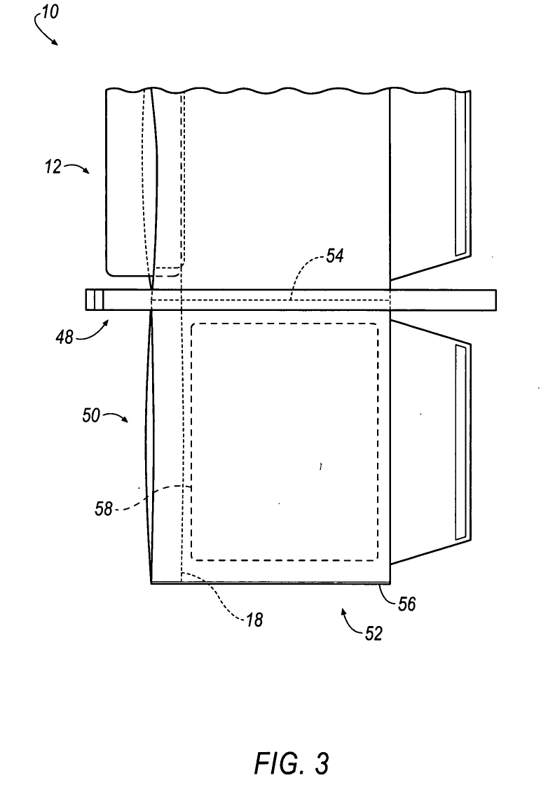

In the embodiment depicted in FIG. 1, the sever and seal device 40 is shown in an open or un-severing and un-sealing position. Here, the sever and seal device 40 is open, thereby allowing an item 58 to be dropped along path 64 such that it falls into the bag material 12 as shown. The sealed surface or edge 56, formed during a previous cycle of the bag forming device 10, prevents the item 58 from falling out through the edge 56. In FIG. 3, the sever and seal device 48 closes and severs and seals the bag material 12 to form edge 54 of a bag 52. Additionally, fold 18, which has been pushed toward an interior of the bag material 12, is locked into place by virtue of the formation of edges 54 and 56 by the sever and seal device 48. As shown in FIG. 4, upon release from the a sever and seal device 48, the bag 52, having edges 54 and 56, is released. Also, a new edge 56a a is formed at an upper portion of the bag material 12 which will serve as an edge 56 of a new bag 52 during a next cycle of the bag formation device 10. Additionally, the bag 52 has a pleat 50 formed by the fold 18 that has been pressed toward the interior of the bag material 12 by the pleat formation device 40. The pleat 50 generally is comprised of fold 18 and edges 62. In an embodiment, the pleat 50 assists in helping the bag to stand upward when set on the pleat 50.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A bag forming device, comprising:
a movement device adapted to move bag material in a folded configuration through the bag forming device along a path, wherein the folded configuration provides a first portion and a second portion of the bag material joined at a fold; and
wherein the first portion is wider in a width direction than the second portion such that the first portion extends wider than the second portion.

2. The bag forming device according to claim 1, wherein:
a resealable seal formation device adapted to place a resealable seal on the first portion;
wherein the first portion resealably connects to the second portion to resealably seal a bag formed from the bag material.

3. The bag forming device according to claim 1, further comprising a cutting tool adapted to remove material from an area of the first portion that extends wider than the second portion.

4. The bag forming device according to claim 3, wherein the cutting tool has an angled configuration adapted to form an angled configuration in the area of the first portion that extends wider than the second portion.

5. The bag forming device according to claim 2, wherein:
the seal is an adhesive strip; and
the adhesive strip is removable to leave an adhesive material on the first portion.

6. The bag forming device according to claim 1, further comprising:
a sever and seal device positioned to sever and seal the bag material across the path;
wherein the movement device is adapted to move the bag material to at least a first position and a second position;
wherein the sever and seal device is adapted to sever and seal the bag material at the first position and the second position to form a first edge and a second edge of the bag;
wherein the fold forms a third edge of the bag.

7. The bag forming device according to claim 6, wherein:
the first portion is wider in a width direction than the second portion such that the first portion extends wider than the second portion at a fourth edge;
wherein the fourth edge is positioned opposite from the third edge and defines an opening of the bag.

8. The bag forming device according to claim 6, further comprising:
a pleat formation device in contact with the bag material at a location proximate the fold;
wherein the pleat formation device is configured to push bag material toward an interior of the bag;
wherein the bag material is affixed at the interior of the bag when the sever and seal device severs and seals the bag material at the first position and the second position to form the pleat.

9. The bag forming device according to claim 8, wherein:
the pleat formation device includes a center portion extending toward the interior of the bag and at least two side portions positioned relatively away from the interior of the bag; and
the center portion pushes the bag material toward an interior of the bag.

10-17. (canceled)

18. A bag forming device, comprising;
a movement device adapted to move bag material in a folded configuration through the bag forming device in a machine direction, wherein the folded configuration provides a first portion and a second portion of the bag material joined at a fold, the first portion extending beyond the second portion in a cross-machine direction; and
a cutting tool arranged and configured to remove an area of the first portion extending beyond the second portion to at least partially define a bag flap.

19. The device of claim 18 further comprising a resealable seal formation device arranged and configured to place a resealable seal on the first portion extending beyond the second portion and outside the area removed by the cutting tool.

20. The device of claim 19, wherein the resealable seal comprises a removable tape that, upon removal, leaves an adhesive material.

21. The device of claim 18 further comprising a sever and seal device positioned to sever and seal the bag material in the cross-machine direction at locations spaced-apart from each other in the machine direction to form opposite edges of a bag.

22. The device of claim 18 further comprising a pleat formation device configured to form a pleat in the bag material at the fold.
